(19) United States
(12) Patent Application Publication
(10) Pub. No.: US 2022/0070144 A1
(43) Pub. Date: Mar. 3, 2022

(54) SYSTEMS, DEVICES, AND METHODS FOR PROVIDING A SECURE CLIENT

(71) Applicant: ID Technologies, LLC, Ashburn, VA (US)

(72) Inventor: Dylan Conner, Ashburn, VA (US)

(21) Appl. No.: 17/459,695

(22) Filed: Aug. 27, 2021

Related U.S. Application Data
(60) Provisional application No. 63/071,059, filed on Aug. 27, 2020.

(51) Int. Cl. H04L 29/06

(52) U.S. Cl. CPC H04L 63/0236; H04L 63/0414; H04L 63/20; H04L 63/0263

(57) ABSTRACT

A secure portable electronic device, including a communications device, and an internal retransmission device. For the transmission of black data transports, the communication device is disabled and the internal retransmission device is enabled.

### CROSS REFERENCE TO RELATED APPLICATIONS

This application is a non-provisional application that claims the benefit of U.S. provisional Application No. 63/071,059, filed on Aug. 27, 2020, the contents of which are herein incorporated by reference in their entirety.

### BACKGROUND OF THE INVENTION

### Field of the Invention

The embodiments of the present invention generally relate to communications systems, devices, and methods, and more particularly, to highly secure communications systems, devices, and methods, as described herein.

### Discussion of the Related Art

In today's information age, data privacy and data security are critical to the functioning of our society. Widespread use of the Internet and the proliferation of mobile devices have created a world in which individuals, businesses, and nations are more connected than ever before. The Internet of Things (IoT), backed by edge computing, machine learning, data analytics, and cloud technology, is accelerating and amplifying those connections. Currently, the number of IoT connected devices worldwide is expected to reach 41.6 billion by 2025.

As the world becomes more connected, however, it also becomes less secure. With each new connected device, vulnerabilities multiply, resulting in a rapid increase in the number of successful cyberattacks and data breaches worldwide. In 2019, the total cost of cybercrime exceeded USD $2 trillion—a fourfold increase since 2015. Globally, malicious hackers, cyberterrorists, and other cybercriminals are a growing threat to consumer finances, business operations, and public safety. According to the January 2019 edition of the U.S. National Intelligence Strategy Report, “Cyber threats will pose an increasing risk to public health, safety, and prosperity as information technologies are integrated into critical infrastructure, vital national networks, and consumer devices.”

U.S. government organizations and individuals who routinely handle classified information and safeguard national security—from military and intelligence services to designated national leaders in the executive and legislative branches—require highly secure access to mobile resources in diverse locations. Increasingly, the same is true for law enforcement and many enterprise organizations that must ensure data security, protect critical infrastructure, and guard against attacks by cybercriminals and cyberterrorists. Unfortunately, many high-security or encryption solutions are expensive, complex, inflexible, difficult to scale, and hard to manage and maintain.

The Mobile Access Capabilities Package (“MACP”) is an example of a government effort to secure information by the National Security Agency (“NSA”). The NSA frequently collaborates with other security agencies, the armed forces, law enforcement, and third party companies, such as government defense contractors to develop national defense solutions. In such collaborations, information is often exchanged according to an initiative called the Commercial Solutions for Classified Programs (“CSfC”). Developed by the NSA, the CSfC program is an important part of the U.S. Government's strategy to more quickly deliver layered cybersecurity solutions by leveraging emerging technologies and commercial products to meet rapidly evolving security requirements. For example, the CSfC mandates the use of a retransmission device for black transports (e.g., confidential data, classified data, sensitive data, etc.) except government private wireless and government private cellular. NSA documentation, such as “INFORMATION ASSURANCE CAPABILITIES Mobile Access Capabilities Package v2.1” dated 26 Jun. 2018, describes example system architecture and design. An update, v2.5, was recently approved.

Unfortunately, current systems present a number of drawbacks. For example, most commercially available retransmission devices are bulky and lack appropriate security features. In addition, most commercially available retransmission devices are produced abroad (e.g., China, Taiwan, or Hong Kong) and may contain spyware. Moreover, the retransmission device is yet another piece of equipment that the user must maintain, carry, and track.

Other companies have attempted to use a client virtualization process (e.g., OpenXT, Vmware workstation, KVM) to segment (or virtualize) the different workloads on the client system. However, current solutions highlight the lack of reliable client computing segmentation of services that are unable to effectively allow for multiple, independent processes to run as part of a larger system self-contained on one computing device. In addition, such solutions have very real configuration and security issues such as vulnerabilities in the client hypervisor.

### SUMMARY OF THE INVENTION

Accordingly, the present invention is directed to systems, devices, and methods for providing a secure client device that substantially obviates one or more problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, systems, devices, and methods for providing a secure client device are provided.

In another aspect, a secure portable electronic device, including a communications device, and an internal retransmission device is provided. For the transmission of black data transports, the communication device is disabled and the internal retransmission device is enabled.

In another aspect, a method for operating a secure portable electronic device is provided, including communicating with an untrusted network via a communications device, disabling the communications device, enabling an internal retransmission device, and communicating with the untrusted network via the internal retransmission device, wherein, for the transmission of black data transports, the communication device is disabled and the internal retransmission device is enabled.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of a secure client device in accordance with an example embodiment of the present invention.

FIG. 2 illustrates incorporation of an internal retransmission device into a portable electronic device in accordance with an example embodiment of the present invention.

FIGS. 3A, 3B, 3C, and 3D illustrate respective modes of operation for an internal retransmission device in accordance with example embodiments of the present invention.

FIG. 4 illustrates configurations of the secure client device in accordance with example embodiments of the present invention.

FIG. 5 illustrates a retransmission device in accordance with another example embodiment of the present invention.

FIG. 6 illustrates a dashboard in accordance with an example embodiment of the present invention.

### DETAILED DESCRIPTION OF THE INVENTION

Reference will now be made in detail to the embodiments of the present invention, examples of which are illustrated in the accompanying drawings.

Embodiments of user interfaces, components, and associated methods for using a secure client device are described. In some embodiments, the secure client device is a portable communication device (e.g., a laptop, a mobile phone, or a tablet). The user interface may include a touch screen, a gyroscopic or other acceleration device, and/or other input/output devices. In the discussion that follows, a portable communications device is used as an example embodiment. It should be understood, however, that the user interfaces and associated methods may be applied to a variety of devices, such as personal computers, security cameras or sensors, industrial controllers, unmanned vehicles, robotics, and laptops, that may include one or more other physical user-interface devices, such as a keyboard and/or mouse.

The secure client device may support a variety of applications, such as telephone, e-mail, text messenger, word-processing, file-sharing, and calendar applications. The various applications that may be executed on the device may use at least one common physical user-interface device, such as a touchscreen. One or more functions of the touch screen as well as corresponding information displayed on the device may be adjusted and/or varied from one application to another and/or within a respective application. In this way, a common physical architecture of the secure client device may support a variety of applications with user interfaces that are intuitive and transparent. In the discussion that follows, a secure client device having data security component(s) and/or application(s) is used as an example embodiment, but it should be understood that the user-interfaces, components, and associated methods may be applied to other applications.

According to the embodiments of the invention, a secure client device is provided. The secure client device is the first turnkey mobility solution that complies with CSfC requirements. For example, the secure client device includes an internal retransmission device that simplifies the user experience for those at home or in the field and provides a flexible option for connectivity for end users. The internal retransmission device does not preclude the use of other, government approved, retransmission devices that may be used in the alternative or in combination.

In CSfC mobile access deployments, retransmission devices are used to protect communications across untrusted networks (e.g., public networks) by providing a layer of obfuscation between the components of a CSfC solution and components that control communication across untrusted networks, such as Wi-Fi, LTE, 4G, or 5G networks. For example, the retransmission device includes a connection to solution infrastructure, via a black transport network, and on the external side, may be connected to an untrusted network such as Wi-Fi, LTE, 4G, or 5G networks. Other network connection examples include cellular, SATCOM, Ethernet, etc. The retransmission device is configured to ensure that by the time any components of the untrusted network receive the data, it has already been encrypted twice.

Commonly referred to within the Department of Defense (“DoD”) as the “baseband problem”, commercially used cellular chips allow for external control, or access, from the cell towers that connect them to the network. For instance, when your phone connects to a cell tower, the cellular carrier has access to configure and tune settings on the cellular chip to enhance call quality and connection. Consequently, external parties are able to execute changes, and potentially hijack the cellular chip. In order to ensure that data is protected in the event this happens, it is very important to separate the functions of the cellular chip from other functions that involve accessing data, or controlling the CSfC solution like major CPU functions or direct memory access. Additionally, with a retransmission device, any data that is to be transmitted will have already been encrypted twice, thus being able to safely traverse over black transport networks, by the time the data reaches components of the cellular network. At this point, there is no longer risk to the data.

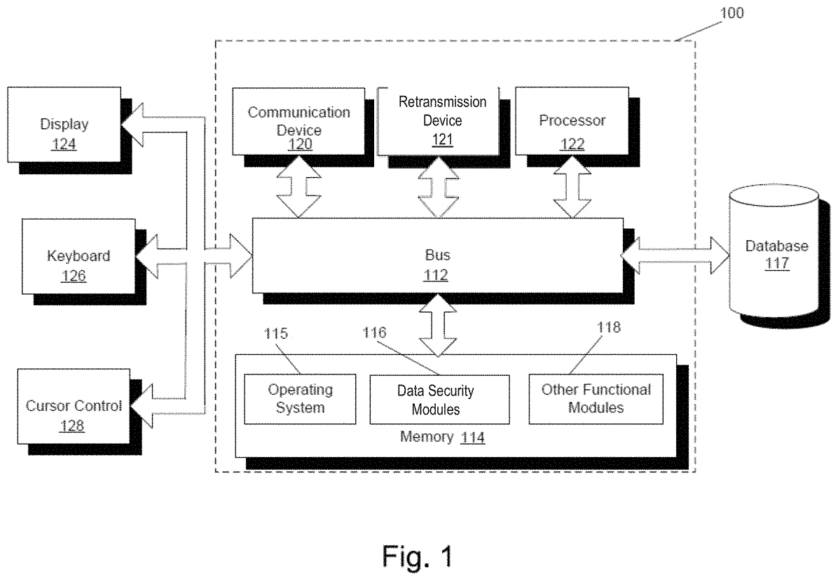

FIG. 1 is a block diagram of a secure client device 100 in accordance with an example embodiment of the present invention.

As illustrated in FIG. 1, secure client device 100 may include a bus device 112 and/or other communication mechanism(s) configured to communicate information between the various components of secure client device 100, such as processor 122 and memory 114. In addition, communication device 120 may enable connectivity between processor 122 and other devices by encoding data to be sent from processor 122 to another device over a network (not shown) and decoding data received from another system over the network for processor 122.

For example, communication device 120 may include a network interface card that is configured to provide wireless network communications. A variety of wireless communication techniques may be used including infrared, radio, Bluetooth, Wi-Fi, and/or cellular communications. Alternatively, communication device 120 may be configured to provide wired network connection(s), such as an Ethernet connection.

Internal retransmission device 121 may include a network interface card that is configured to provide wireless network communications. A variety of wireless communication techniques may be used including infrared, radio, Bluetooth, Wi-Fi, and/or cellular communications. Alternatively, internal retransmission 121 device may be configured to provide wired network connection(s), such as an Ethernet connection.

Although not illustrated, retransmission device 121 may include a standalone memory (e.g., internal RAM and/or available internal storage capacity), a standalone processor and/or microcontroller, and other communication components to enable RF or Ethernet communications, such as Wi-Fi, LTE, 4G, 5G, or SATCOM communications, and other wired or wireless communication systems.

Processor 122 may comprise one or more general or specific purpose processors to perform computation and control functions of secure client device 100. Processor 122 may include a single integrated circuit, such as a micro-processing device, or may include multiple integrated circuit devices and/or circuit boards working in cooperation to accomplish the functions of processor 122. In addition, processor 122 may execute computer programs, such as operating system 115, data security modules 116, and other applications 118, stored within memory 114.

Secure client device 100 may include memory 114 for storing information and instructions for execution by processor 122. Memory 114 may store software modules that provide functionality when executed by processor 122. The modules may include an operating system 115 that provides operating system functionality for secure client device 100. The modules can include data security modules 116 configured to provide firewall and/or virtual private network functionality for communication device 120 and/or internal retransmission device 121. Operating system 115 provides operating system functionality for secure client device 100, data security modules 116 may include one or more application program interfaces (“API”) that enable users to select an encryption scheme or to select a VPN from among a plurality of VPNs. In some instances, data security modules 116 may be implemented as an in-memory configuration that is used to generate and execute rule scripts that control content displayed within an application or webpage, as will be described in more detail below.

Non-transitory memory 114 may include a variety of computer-readable medium that may be accessed by processor 122. For example, memory 114 may include any combination of random access memory (“RAM”), dynamic RAM (“DRAM”), static RAM (“SRAM”), read only memory (“ROM”), flash memory, cache memory, and/or any other type of non-transitory computer-readable medium.

Processor 122 is further coupled via bus 112 to a display 124, such as a Liquid Crystal Display (“LCD”). A keyboard 126 and a cursor control device 128, such as a computer mouse, are further coupled to communication device 112 to enable a user to interface with secure client device 100.

Internal retransmission device 121 of secure client device 100 provides enhanced security for data transmitted over untrusted networks, such as data stored in database 117. Database 117 is coupled to bus 112 to provide centralized storage for modules 116 and 118. Database 117 can store data in an integrated collection of logically-related records or files. Database 117 can be an operational database, an analytical database, a data warehouse, a distributed database, an end-user database, an external database, a navigational database, an in-memory database, a document-oriented database, a real-time database, a relational database, an object-oriented database, or any other database known in the art.

One or more components of secure client device 100 may not be included. For example, for functionality of a user client, secure client device 100 may include a processor, memory, and a display, but may not include one or more of the other components illustrated in FIG. 1.

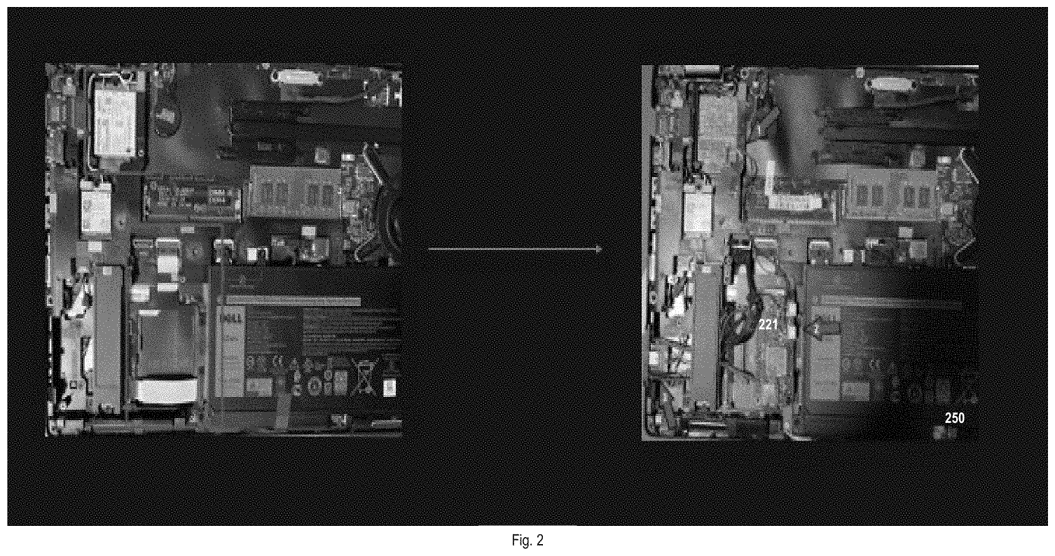

In an example embodiment, secure client device 100 may be a commercially available laptop. Commercially available laptops, such as the Dell 5400s, often utilize a small solid-state drive (“SSD”) card which leaves the standard hard drive bay empty. According to an example embodiment of the invention, the space of the empty bay or another space may be configured for internal retransmission device 121. In some configurations, the wireless wide area network (“WWAN”) card slot may be used for a USB Ethernet connection for spaces where Wi-Fi is not allowed. Additionally, or alternatively, internal retransmission device 121 only receives power from its host secure client device 100. Otherwise, internal retransmission device 121 has no software or logical integration with secure client device 100 and is configured to operate as a fully standalone wireless router. As an example, physical or actual incorporation of an internal retransmission device is illustrated in FIG. 2.

FIG. 2 illustrates incorporation of an internal retransmission device 221 into a portable electronic device in accordance with an example embodiment of the present invention.

By placing the internal retransmission device 221 internally to the portable electronic device, a secure client device (e.g., secure client device 100) is achieved. For example, internal retransmission device 221 may be placed at locations 1 and/or 2 of an internal circuit board 250 (e.g., an M2 slot, or PCI slot using an adaptor or riser card), and physical access to the internal retransmission device 221 is restricted. This physical access restriction increases the internal retransmission device's security posture, enhances user experience, and ensures user compliance with the use of internal retransmission device 221. By implementing the embodiments of the invention, use of an external retransmission device is avoided. Accordingly, there is no need for an additional device for the user to keep track of or accidentally damage.

Moreover, use of internal retransmission device 221 is transparent to the user experience. In some configurations, to further enhance the security of the secure client device and internal retransmission device 221, Wi-Fi on the secure client device may be disabled. By disabling Wi-Fi, the secure client device communicates sensitive data using only internal retransmission device 221.

Escalating in complexity, cyberattacks are moving down the computing stack—from software to hardware—making it increasingly difficult for the legacy model of software protecting the system to cope and keep pace with rapidly advancing threats to digital security, safety and privacy. Accordingly, the standalone configuration of internal retransmission device 221 enhances the security of the secure client device.

Internal retransmission device 221 may be configured as a layer 3 router and not as a repeater. As such, certain protocols are observed. Packets, such as broadcast or multicast, are considered non-routable and are not transferred through internal retransmission device 221. Because internal retransmission device 221 is configured as a router, it supports features to include stateful firewall, network address translation (NAT), and port forwarding. Incoming sessions not initiated by the secure client device, regardless of protocol, may be terminated at internal retransmission device 221 unless the local policy dictates a firewall exemption.

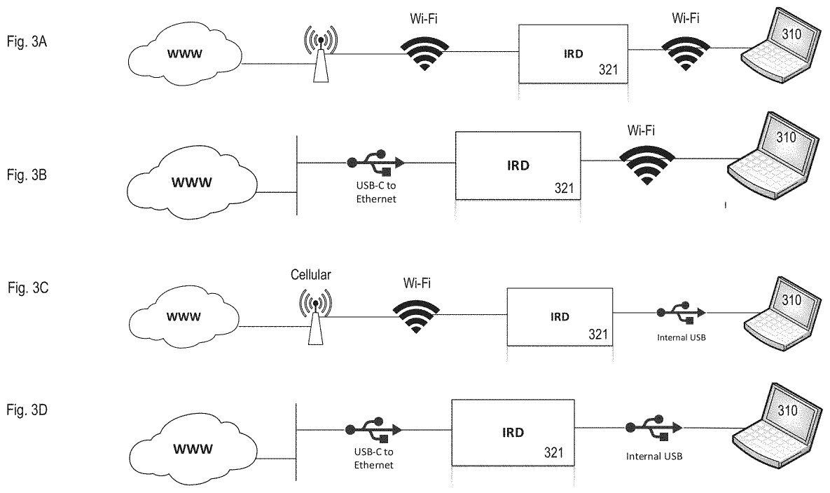

FIGS. 3A, 3B, 3C, and 3D illustrate respective modes of operation for an internal retransmission device 321 in accordance with example embodiments of the present invention. In particular, internal retransmission device 321 may include multiple modes of operation in compliance with MACP, such as: (i) Wi-Fi-To-Wi-Fi Mode; (ii) Wi-Fi to Ethernet Dongle mode; (iii) USB (internal) to Wi-Fi mode; and (iv) USB (internal) to Ethernet Dongle mode.

As illustrated in FIG. 3A, when the user connects via Wi-Fi on both the client and network side, the connection between secure client device 310 and internal retransmission device 321 operates as a standard Wi-Fi connection using WPA2. The network side is driven by the network configuration. Here, internal retransmission device 321 serves a layer 3 router and not as a repeater. This allows the use of features such as firewall, port forwarding, and NAT.

In another example configuration, as illustrated in FIG. 3B, the Wi-Fi side to the client is identical to above. In this example embodiment, however, the Ethernet dongle connects directly to the network side of internal retransmission device 321 using USB and the network connection is over Ethernet. Routing is still performed by internal retransmission device 321 and all security features are still available.

In another example configuration, as illustrated in FIG. 3C, the USB internal mode presents itself as a SLIP Ethernet appliance which connects to secure client device 310 via Ethernet. This allows for Wi-Fi to be disabled on secure client device 310. Routing is still performed by internal retransmission device 321 and all security features are still available. The availably of the Wi-Fi connection on the secure client device side may be disabled on install. Also, the chip performing connectivity externally will be performed via the Wi-Fi/WAN processor or an Ethernet Dongle which is separate from the main processor of internal retransmission device 321. Lastly, the security features included in the operating systems may be configured to ensure proper packet filtering and protocol breaks are implemented.

In yet another configuration, as illustrated in FIG. 3D, the USB internal mode presents itself as a USB/SLIP Ethernet appliance which connects to the host at Layer 2 and feeds packets into the routing function. Again, all packets go through a router mechanism and are not simply repeated. The network routes packets to the Ethernet interface that meet the routing criteria. The host requests an address from internal retransmission device 321 (or static) and the internal retransmission device requests and address from the network (or static). Because it is a routing function, the subnets are non-overlapping.

In addition to the incorporation of the internal retransmission device according to the various embodiments, the embodiments of the invention are further directed to a combination of a user focused secure client device with a secure real-time operating system (“RTOS”) separation kernel that provides multiple processing spaces in combination with a factory provisioning process that specifies the configuration and relationship of these processing spaces.

In addition, the secure client device according to the embodiments does not use a hypervisor, it uses a virtual address space with virtual BIOS or a direct application running on the secure RTOS. This segmentation, combined with an immutable configuration, provides a solution with much less management overhead, greater performance, and flexibility.

According to some embodiments, secure client device (e.g., 100, 310, 510) is enhanced by the security and reliability of its operating system, such as INTEGRITY from Green Hills Software. In addition, the secure client device may be configured to use the INTEGRITY Separation Kernel, which has been certified for the highest levels of safety and reliability in the INTEGRITY-178B Operating System. The INTEGRITY Separation Kernel is the first and only separation kernel to be evaluated by the NSA and certified by National Information Assurance Partnership (NIAP) to EAL6+ High Robustness under the international Common Criteria standard (ISO/IEC 15408). This security rating certifies that the product is suitable for the protection of classified information and other high-value resources against well-funded, sophisticated attackers.

In its various configurations, the secure client device of the invention may be configured to use commercially available technology, such as an Intel® Core™ vPro™ processor powered laptop. Intel VT and Intel TXT are built into the hardware of the Intel vPro platform and enable the hypervisor to secure operating systems, applications, and data by keeping them isolated on their own Virtual Machines (VM), running in their own virtual hardware environment. Each VM is prevented from accessing another VM's OS, applications, data and input/output (I/O). Intel TXT enables a dynamic root of trust to ensure VMs are running on trusted hardware with trusted software, by allowing greater control of the launch stack through a Measured Launch Environment (MLE) and enabling isolation in the boot process. This creates the ability to verify the security of installation, launch, and use of the hypervisor and operating systems. These technologies provide a highly scalable architecture that is specifically designed to harden platforms against hypervisor and BIOS attacks, malicious root kit installations, and other firmware- or software-based attacks.

Accordingly, the embodiments of the invention provide the implementation of a real time operating system on a commercial computing client, allowing for segmentation of the system resources to run different standalone applications, services, and operating system as a system. In combination with these features, communications of sensitive information are routed through an internal retransmission device.

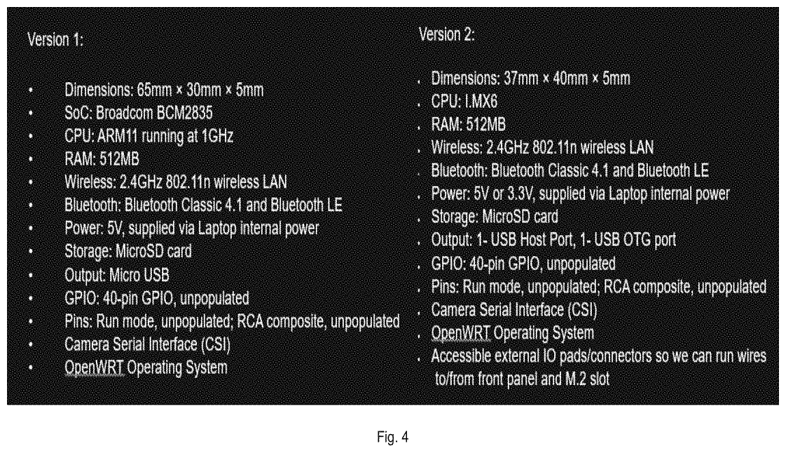

Other configurations of software and hardware are also feasible. The secure client device may execute a variety of common client operating system or applications, including native applications that are running on Portable Operating Systems Interface (“POSIX”) compliant operating systems including Windows, Linux, Android, and UNIX type operating systems. In another example, the secure client device may be configured as illustrated in the configurations of FIG. 4.

FIG. 4 illustrates configurations of the secure client device in accordance with example embodiments of the present invention. Additionally, a variety of commercially available electronic devices may be enhanced by incorporation of an internal retransmission device to create a secure client device that implements security models such as the NSA's CSfC capability packages. The secure client device may be created in the factory, without the cost, complexity, and management overhead of currently available solutions.

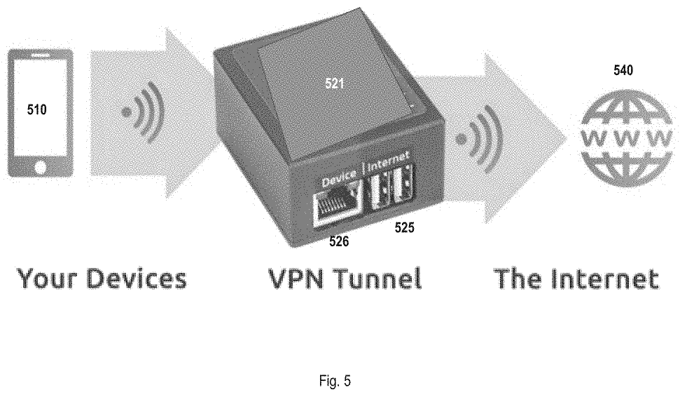

FIG. 5 illustrates a retransmission device 521 in accordance with another example embodiment of the present invention. By contrast to the other embodiments, retransmission device 521 may be configured as either an internal or external retransmission device. Additionally, or alternatively, an external retransmission device 521 may be used in combination with an internal retransmission device such as internal retransmission device 121 (illustrated in FIG. 1).

Retransmission device 521 may include a plurality of standalone or integrated components such as a processor, memory, and communication components to implement a combination of VPN, firewall, and Wi-Fi hotspot functionality.

A first communication link is formed between a portable electronic device 510 and retransmission device 521. A second communication link is formed between retransmission device 521 and an untrusted network 540, such as a public network connected to the Internet.

The connections formed by retransmission device may be formed using one or more Wi-Fi adaptors using USB or micro USB ports 525 and/or one or more Ethernet adaptors 526. Alternatively, a plurality of integrated or built-in Wi-Fi chips may be used to concurrently provide LAN and WAN capabilities.

Retransmission device 521 establishes a VPN tunnel between portable electronic device 510 and untrusted network 540 through retransmission device 521, the user of portable electronic device 510 may connect to one or more servers that can access a virtual machine (“VM”) or cloud device (e.g., Azure, Amazon Web Services (“AWS”), or any other cloud provider), or enterprise network. Alternatively, or additionally, the user may connect to a (global) obfuscation network that makes the user's identity anonymous and the user's location unknown. Alternatively, or additionally, the user may connect to a variety of file-sharing platforms in a secure manner.

Here, the VPN tunnel extends a private network across a public network and enables users to send and receive data across shared or public networks as if their computing devices were directly connected to the private network. Applications running across a VPN may benefit from the functionality, security, and management of the private network.

A variety of tunneling protocols may be used to enable movement of data from one network to another, and particularly, private network communications to be sent across a public network (e.g., the Internet) through a process called encapsulation. Example tunneling protocols include Secure Shell (“SSH”) tunnel, Secure Sockets Layer (“SSL”), Transport Layer Security (“TLS”), Internet Protocol Security (IPsec), Internet Key Exchange (IKEv1, IKEv2). IKE was initially developed by Microsoft and Cisco and is used in conjunction with IPSec for encryption and authentication primarily in mobile devices, whether on 3G, 4G, LTE, or other networks.

Retransmission device 521 further includes a firewall (not shown) that monitors and controls incoming and outgoing network traffic based on predetermined security rules. The combination of a VPN and firewall ensures data security between a trusted network and an untrusted network, such as the Internet.

Retransmission device 521 further may be configured to use a trusted platform module (“TPM”) for secure key storage. TPM, also known as ISO/IEC 11889, is an international standard for a secure cryptoprocessor, a dedicated microcontroller designed to secure hardware through integrated cryptographic keys. A variety of TMPs can be used, including, for example, discrete TPMs, integrated TPMs, Firmware TPMs, Hypervisor TPMs, Software TPMs, etc.

Retransmission device 521 and internal retransmission device 121 effectively isolate captive portals. A captive portal is a web page accessed with a web browser or application screen that is displayed to newly connected users of a Wi-Fi or wired network before they are granted broader access to network resources. For example, a captive portal is frequently used to provide access to enterprise or residential wired networks, such as apartment houses, hotel rooms, and business centers.

In some configurations user device 510 may be a wired or wireless router. For example, when retransmission device 521 is coupled to a wireless router, a plurality of Wi-Fi connections may be concurrently supported (e.g., 5 concurrent Wi-Fi Devices (LAN)). In another example, when retransmission device 521 is coupled to an Ethernet router, a plurality of wired Ethernet connections may be concurrently supported (e.g., 30 concurrent Ethernet Devices (LAN)). Thus, the embodiments provide a cost-effective solution to secure a large number of active portable electronic devices concurrently.

Although an example retransmission device 521 is illustrated in FIG. 5, alternate configurations are possible. For example, various port, power, light indicator configurations are feasible depending upon user need (e.g., 3 Ethernet ports, 1 USB Aux port, 3 status LEDs, USB-C power, and power/reset button). Retransmission device 521 may be plugged-in to a power source and/or may include circuitry designed to support optional battery power and charging.

Although not illustrated, retransmission device 521 may include a memory (e.g., 1 GB of internal RAM and/or 8 GB of available internal storage capacity), a processor (e.g., Quadcore 1.5 GHz ARM Processor), and other communication components to enable Ethernet, Wi-Fi, LTE, 4G, or 5G communications.

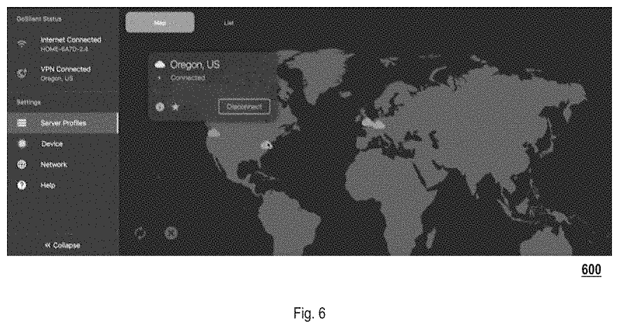

FIG. 6 illustrates a dashboard in accordance with an example embodiment of the present invention. As illustrated in FIG. 6, user dashboard 600 identifies which VPN of a plurality of VPNs is active, and enables the user to select among a plurality of VPNs to select alternate VPNs having different geographical locations to change where the user appears to be connected from. Alternatively, or additionally, the user may connect to a (global) obfuscation network that makes the user's identity anonymous and the user's location unknown.

By using retransmission devices described herein, even the least secure connections become incredibly secure. Even the most sensitive data can be protected on public or untrusted networks. In addition, the embodiments provide easy techniques to secure any user or device simply by connecting to the retransmission device. Compatible with any IP-enabled device (no matter how old) and effective over any connection (no matter how public) with near zero configuration required.

It will be apparent to those skilled in the art that various modifications and variations can be made in the systems, devices, and methods for providing a secure client device of the present invention without departing from the spirit or scope of the invention. Thus, it is intended that the present invention cover the modifications and variations of this invention.

1. A secure portable electronic device, comprising:
a communications device; and
an internal retransmission device,
wherein, for the transmission of black data transports, the communication device is disabled and the internal retransmission device is enabled.

2. The secure portable electronic device according to claim 1, wherein the communications device and the internal retransmission device are physically internal to the secure portable electronic device.

3. The secure portable electronic device according to claim 1, wherein each of the communications device and the internal retransmission device is configured to communicate with Wi-Fi, LTE, 4G, and/or 5G networks.

4. The secure portable electronic device according to claim 1, wherein the internal retransmission device is configured to operate as a standalone router.

5. The secure portable electronic device according to claim 1, wherein the internal retransmission device is configured to operate as a layer three router.

6. The secure portable electronic device according to claim 1, wherein the internal retransmission device is a router and includes stateful firewall, network address translation (NAT), and port forwarding.

7. The secure portable electronic device according to claim 1, wherein the internal retransmission device is physically located in a M2 card slot or a PCI card slot of the secure portable electronic device.

8. The secure portable electronic device according to claim 1, wherein the internal retransmission device is configured to obfuscate the identity and/or location of the secure portable electronic device.

9. The secure portable electronic device according to claim 1, wherein the secure portable electronic device is laptop or tablet computer.

10. A method for operating a secure portable electronic device, comprising:
communicating with an untrusted network via a communications device;
disabling the communications device;
enabling an internal retransmission device; and
communicating with the untrusted network via the internal retransmission device,
wherein, for transmission of black data transports, the communication device is disabled and the internal retransmission device is enabled.

11. The method for operating the secure portable electronic device according to claim 10, wherein the communications device and the internal retransmission device are physically internal to the secure portable electronic device.

12. The method for operating the secure portable electronic device according to claim 10, wherein each of the communications device and the internal retransmission device is configured to communicate with Wi-Fi, LTE, 4G, and/or 5G networks.

13. The method for operating the secure portable electronic device according to claim 10, wherein the internal retransmission device is configured to operate as a standalone router.

14. The method for operating the secure portable electronic device according to claim 10, wherein the internal retransmission device is configured to operate as a layer three router.

15. The method for operating the secure portable electronic device according to claim 10, wherein the internal retransmission device is a router and includes stateful firewall, network address translation (NAT), and port forwarding.

16. The method for operating the secure portable electronic device according to claim 10, wherein the internal retransmission device is physically located in a M2 card slot or a PCI card slot of the secure portable electronic device.

17. The method for operating the secure portable electronic device according to claim 10, wherein the internal retransmission device is configured to obfuscate the identity and/or location of the secure portable electronic device.

18. The method for operating the secure portable electronic device according to claim 10, wherein the secure portable electronic device is laptop or tablet computer.

19. A non-transitory computer readable medium having instructions stored thereon that, when executed by a processor, cause the processor to perform the operations comprising:
communicating with an untrusted network via a communications device;
disabling the communications device;
enabling an internal retransmission device; and
communicating with the untrusted network via the internal retransmission device,
wherein, for transmission of black data transports, the communication device is disabled and the internal retransmission device is enabled.
